(19) United States
(12) Patent Application Publication
(10) Pub. No.: US 2016/0099862 A1
(43) Pub. Date: Apr. 7, 2016

(54) REDUNDANT NETWORK FORMATION

(71) Applicants: Allied Telesis Holdings Kabushiki Kaisha, Tokyo (JP); ALLIED TELESIS, INC., Bothell, WA (US)

(72) Inventor: Daniel Stellick, Geneva, IL (US)

(21) Appl. No.: 14/504,252

(22) Filed: Oct. 1, 2014

(51) Int. Cl. H04L 12/703; H04L 12/24

(52) U.S. Cl. CPC H04L 45/28; H04L 41/0816

(57) ABSTRACT

Redundant links in a network of devices are established. A plurality of devices in the network is configured for communicating data through primary links coupling devices of said plurality of devices. A designated device is configured to receive device data from the plurality of devices. The designated device is further configured to identify a set of devices from the plurality of devices that is operable to establish redundant links in the network. The designated device is further configured to determine configuration data for each device in the set of devices. The designated device is further configured to send the configuration data to the set of devices. The configuration data is operable to establish redundant links for devices in the set of devices in case of a primary link failure.

### BACKGROUND

A network of connected devices typically communicates information through links established among each other. In some instances, links between devices and/or devices themselves may fail, which prevents some or all devices in the network from communicating information with each other and typically results in the loss of information. In data-sensitive applications, the loss of data is undesirable.

### SUMMARY

Accordingly, a need has arisen to create a network that is configured with redundant links in order to maintain communication among devices in the event of a link and/or device failure. For example, there is a need to create a network of redundant links coupling each device to some or all other devices in the network so that the devices maintain communication among the devices through some or all of the redundant links and/or some or all of the remaining primary links.

In some embodiments, a system includes a plurality of devices in a network configured for communicating data through primary links coupling devices of the plurality of devices and a designated device configured to receive device data from the plurality of devices. The designated device may be further configured to identify a set of devices from the plurality of devices that is operable to establish redundant links in the network. The designated device may be further configured to determine configuration data for each device in the set of devices. The designated device may be further configured to send the configuration data to the set of devices. The configuration data may be operable to establish redundant links for devices in the set of devices in case of a primary link failure.

In some embodiments, the designated device may be further configured to update the set of devices and the associated configuration data in response to a change to the network. It is appreciated that the change may be an addition of a device to the network or a removal of a device from the network.

In some embodiments, the primary link failure may cause the set of devices to establish the redundant links for the devices in the set of devices according to the determined configuration data. It is appreciated that the device data may include device identification, communication capabilities of devices in the plurality of devices, and geolocation of devices in the plurality of devices. It is appreciated that the redundant links may be arranged according to a mesh topology.

In some embodiments, a system includes a plurality of devices forming a communication network and a first device of the plurality of devices coupled to a second device of the plurality of device. Devices of the plurality of devices may be networked via their respective primary link. The first device and the second device may be configured to establish a redundant link coupling the first device to the second device to maintain communication between the first device and the second device in presence of a failure associated with communication through the primary link coupling the first device to the second device.

In some embodiments, the system may further include a designated device configured to determine configuration data for the first and second devices and to send the configuration data to the first and second devices to establish the redundant link responsive to the failure associated with communication through the primary link coupling the first device to the second device. It is appreciated that the first and second devices may be further configured to share device data with each other to determine configuration data associated therewith to establish the redundant link responsive to the failure associated with communication through the primary link coupling the first device to the second device. It is appreciated that the device data may include device identification, communication capabilities of the first and second devices, and geolocation of the first and second devices.

In some embodiments, the system may further include a third device that is added to the communication network. It is appreciated that the third device may be configured to communicate device data associated therewith with the first device through a primary link of the third device. It is appreciated that the third device may be configured to communicate device data associated therewith with the first device through a redundant link of the third device.

In some embodiments, the system may further include a third device in communication with the first and the second devices. The first device, the second device, and the third device may form a set of devices. It is appreciated that remaining devices of the formed set of devices maintain communication when one device in the set of devices is removed.

In some embodiments, the first device includes a first communication interface of a first type and a second communication interface of a second type, and the second device includes a first communication interface of the first type and a second communication interface of the second type. The first and second devices may communicate through the primary link via their respective first communication interface. The first and second devices may communicate through the redundant link via their respective second communication interface. It is appreciated that the first type may be based on a wired link and the second type may be based on a wireless link.

In some embodiments, a system includes a first device that includes a first communicating interface and a second communicating interface and a second device that includes a first communicating interface and a second communicating interface. The first communicating interface of the second device may be coupled to the first communicating interface of the first device via a primary link. The first device and the second device may be configured to communicate respective device data associated therewith with one another. The respective device data associated therewith may be used by the first device and by the second device to configure communication between the first device and the second device through their respective second communicating interface via a redundant link in response to a failure associated with communication via the primary link.

It is appreciated that the respective device data associated with the first and second devices may be shared between the first and second devices through a broadcast protocol. In some embodiments, the first communication interfaces of the first and second devices may be of a first type and the second communication interfaces of the first and second devices may be of a second type. It is appreciated that the first type may be based on a wired link and wherein the second type may be based on a wireless link. It is appreciated that the second type may be a radio frequency (RF) interface. It is appreciated that the second type may be a Bluetooth interface. It is appreciated that the respective device data may be communicated through an extension of a link layer discovery protocol (LLDP).

These and various other features and advantages will be apparent from a reading of the following detailed description.

### BRIEF DESCRIPTION OF DRAWINGS

The embodiments are illustrated by way of example, and not by way of limitation, in the figures of the accompanying drawings and in which like reference numerals refer to similar elements.

FIGS. 1A-1G show examples of a network with redundant links established based on a mesh topology in accordance with some embodiments.

FIGS. 2A-2C show examples of a network with redundant links established based on another mesh topology in accordance with some embodiments.

FIGS. 3A-3C show examples of a network with different configurations of redundant links in accordance with some embodiments.

FIGS. 4A-4D show an example of establishing redundant links for a network in accordance with some embodiments.

FIG. 5 shows an exemplary flow diagram for creating configurations for devices to establish redundant links in accordance with some embodiments.

FIG. 6 shows an exemplary flow diagram for configuring a device to establish redundant links in accordance with some embodiments.

FIG. 7 shows an exemplary computer system in accordance with some embodiments.

FIG. 8 shows a block diagram of another exemplary computer system in accordance with some embodiments.

### DETAILED DESCRIPTION

Reference will now be made in detail to various embodiments, examples of which are illustrated in the accompanying drawings. While various embodiments are described herein, it will be understood that these various embodiments are not intended to limit the scope of the embodiments. On the contrary, the embodiments are intended to cover alternatives, modifications, and equivalents, which may be included within the scope of the embodiments as construed according to the appended Claims. Furthermore, in the following detailed description of various embodiments, numerous specific details are set forth in order to provide a thorough understanding of the concept. However, it will be evident to one of ordinary skill in the art that the concept may be practiced without these specific details. In other instances, well known methods, procedures, components, and circuits have not been described in detail as not to unnecessarily obscure aspects of the concept and embodiments.

Some portions of the detailed descriptions that follow are presented in terms of procedures, logic blocks, processing, and other symbolic representations of operations on data bits within a computer memory. These descriptions and representations are the means used by those skilled in the data processing arts and data communication arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “identifying,” “creating,” “generating,” “storing,” “retrieving,” “determining,” “sending,” “receiving,” “transmitting,” “communicating,” “providing,” “accessing,” “associating,” “disabling,” “enabling,” “configuring,” “initiating,” “starting,” “terminating,” “ending,” “configuring,” “forming,” “grouping,” “updating” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, etc. Embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular abstract data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

Embodiments described herein are directed to networks of devices that are configured to establish redundant links among the devices upon failure of a primary link and/or device. In one exemplary embodiment, each device in the network establishes a redundant link with every other device in the network. This way, when one or more primary links coupling the devices fails, the devices may utilize some or all of the redundant and primary links to continue communicating information to each other.

In some embodiments, a subset of the devices in the network may be configured to establish redundant links with each other. Moreover, different sets of devices in the network may use different methods and/or technologies to establish redundant links with each other in different embodiments. For example, one set of devices in the network may use one method and/or technology (e.g., Bluetooth) to establish redundant links while another, different set of devices in the network may use another, different method and/or technology (e.g., Zigbee) to establish redundant links. In some such embodiments, one or more devices may belong to the different sets of devices. This way, the capabilities of devices may be fully utilized to establish redundant links in the network.

In some embodiments, a device is designated to handle the determination of device configurations in order for the devices to establish redundant links with one another. Accordingly, the designated device may be configured to receive, from the devices in the network, device data. It is appreciated that device data, in some embodiments, may be data related to the devices' capabilities to establish redundant links (e.g., whether the device has an alternate way of communicating such as Bluetooth, Zigbee, Wi-Fi, Ethernet, Z-Wave, etc.). Based on the devices' data, the designated device determines configurations for each of the devices and sends the configurations to the respective devices. The devices with multi communication capabilities (e.g., Ethernet and Bluetooth capabilities) then establish redundant links according to the configurations received from the designated device when a link and/or device failure occurs. In some embodiments, the designated device is one of the devices among the connected devices in the network while, in other embodiments, the designated device is a device dedicated to perform such functions and does not belong to the connected devices in the network.

In some embodiments, a device in the network may share its device capabilities with all other devices in the network, some devices in the network, or none of the devices in the network. Moreover, different devices may share its device capabilities with the same or different devices in the network. A device may use any number of different methodologies to share its device capabilities in some embodiments. For instance, a device may share its device capabilities with another device directly, indirectly through one or more intervening devices, and/or through a discovery, announcement, multicast, and/or broadcast protocol of a technology (e.g., Bluetooth, a link layer discovery protocol (LLDP)).

Based on device capabilities received from devices in the network, a device in the network may determine its own configuration for establishing redundant links with other devices in case of a primary link failure, in some embodiments. In this manner, a single device is not responsible for configuring the devices to establish redundant links. That is, such functionality is decentralized/distributed among the devices.

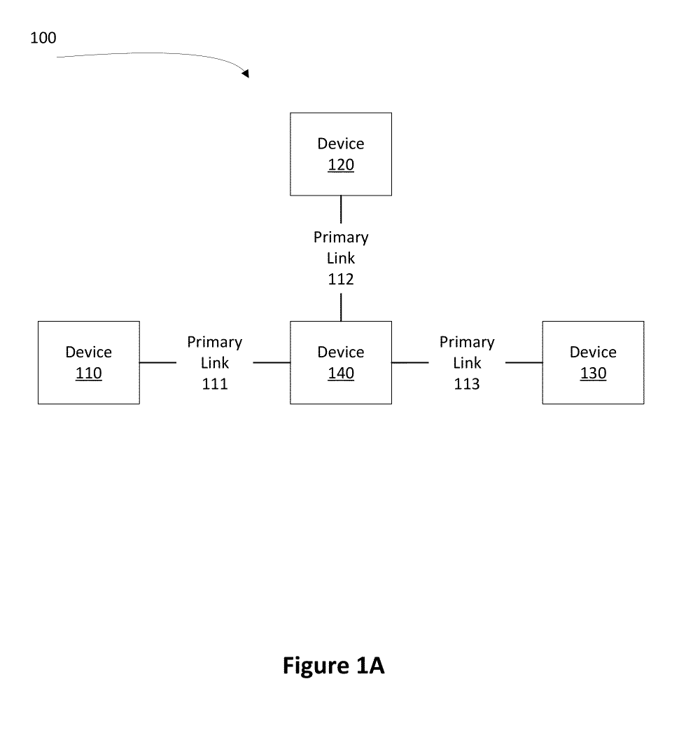

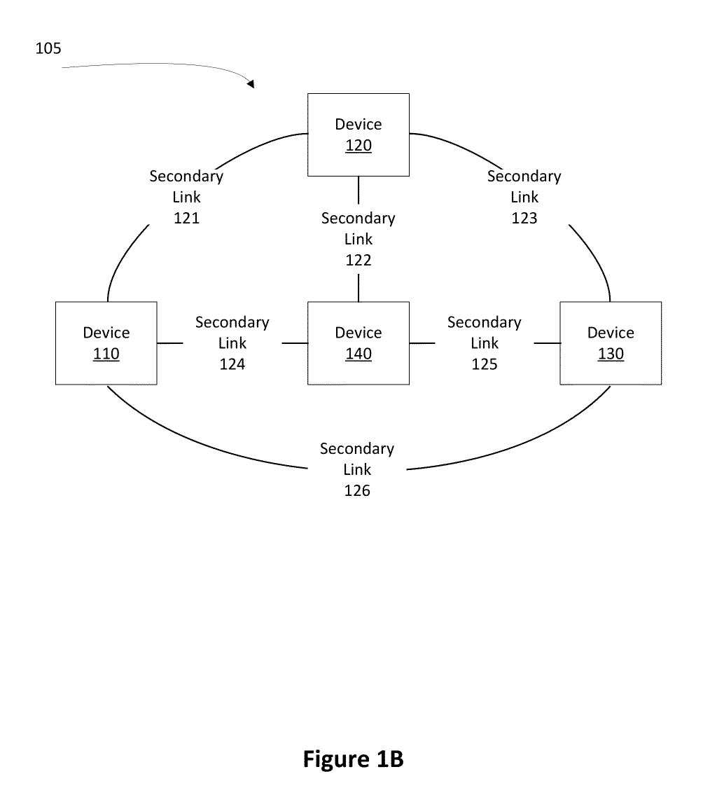

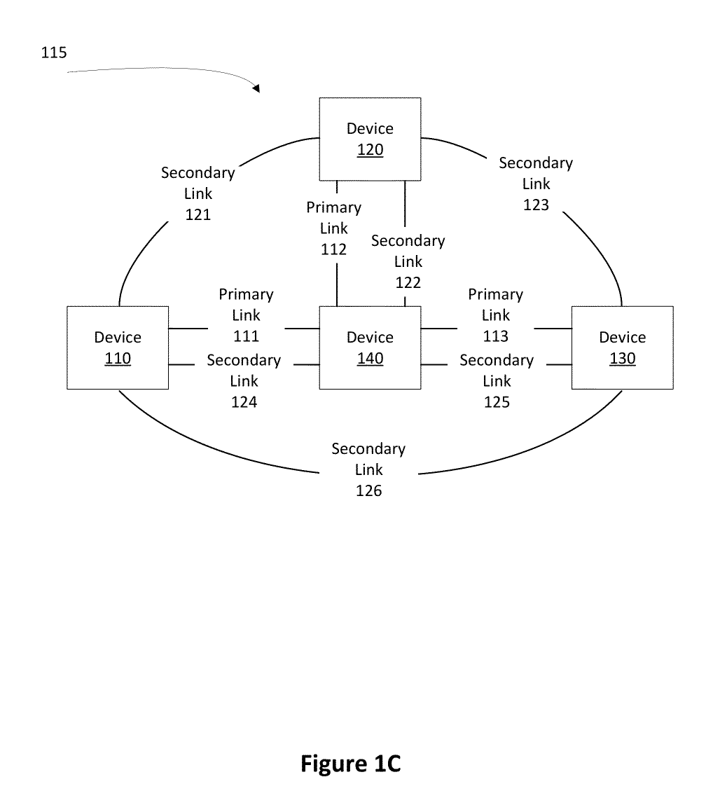

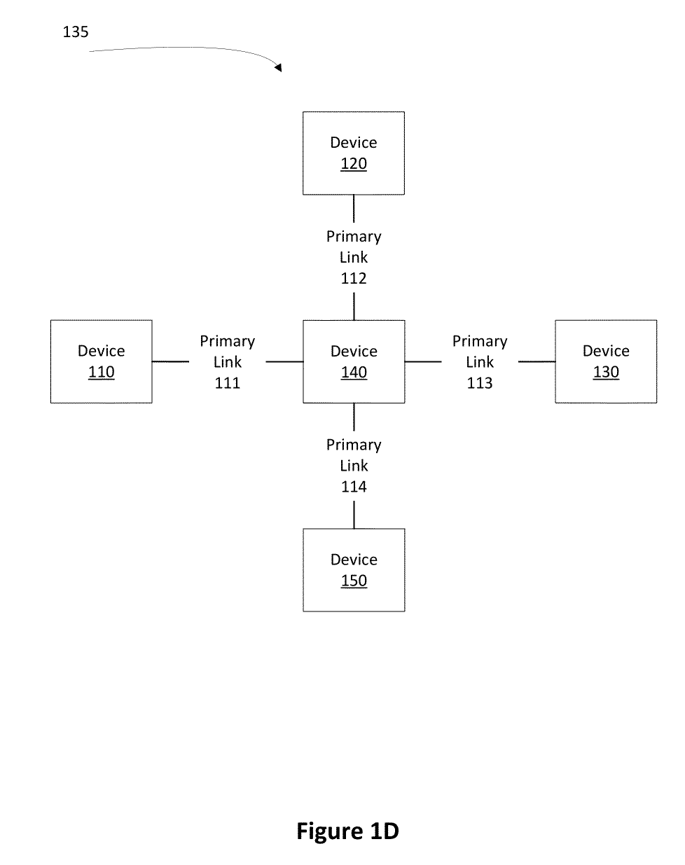

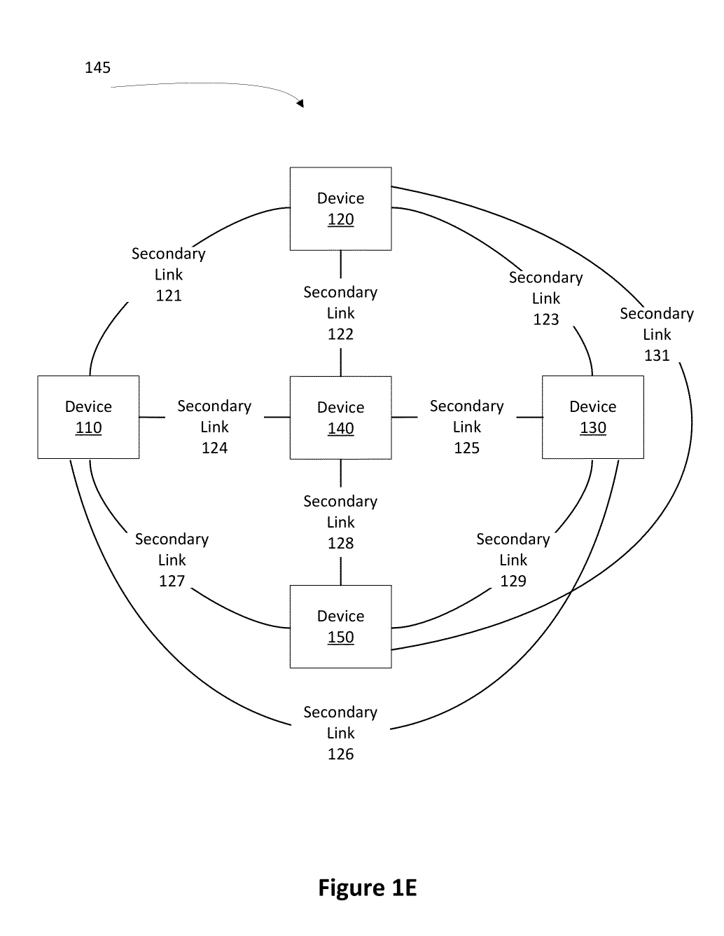

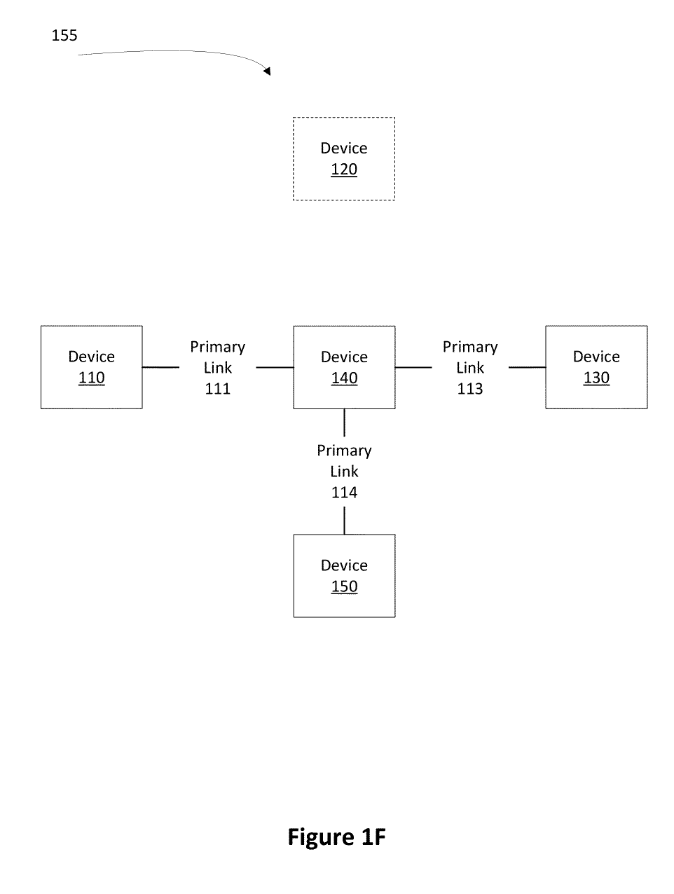

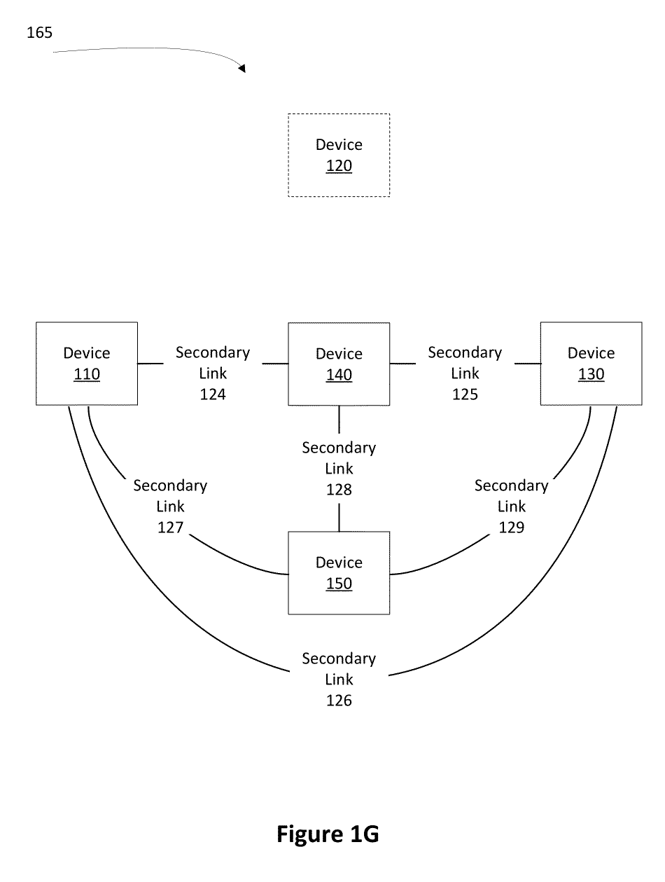

FIGS. 1A-1G show examples of a network with redundant links established based on a mesh topology in accordance with some embodiments. Specifically, FIGS. 1A-1G illustrate a network with redundant links established based on a full mesh topology. Referring now to FIG. 1A, a network 100 with primary links is shown in accordance with some embodiments. In this example, network 100 includes devices 110, 120, 130, and 140. As shown, primary link 111 couples device 110 with device 140, primary link 112 couples device 120 with device 140, and primary link 113 couples device 130 with device 140. In some embodiments, a primary link is a link coupling two devices through which the two devices use to communicate information with each other when the link is available (as opposed to other available links coupling the two devices).

Different embodiments use different methods and/or technologies for implementing primary links 111, 112, and 113 that couple devices 110, 120, 130, and 140. For instance, devices 110, 120, 130, and 140 each have an Ethernet interface and primary links 111, 112, and 113 may be implemented via Ethernet technologies in some embodiments.

It is appreciated that the devices described herein may be any type of device capable of being networked together (e.g., a sensor, an image capture device, a mobile device, a computer, a switch, a router, a hub, a bridge, etc.). In some embodiments, devices 110, 120, 130, and 140 may be the same or similar types of devices while, in other embodiments, some or all of devices 110, 120, 130, and 140 may be different types of devices. For example, each of devices 110, 120, and 130 may be a sensor (e.g., a chemical sensor, a biological sensor, a nuclear sensor, a radiological sensor, a temperature sensor, a pressure sensor, etc.) and device 140 may be a centralized computing device (e.g., a server computer) that receives (e.g., through primary links 111, 112, and 113), stores, analyzes, processes, etc., data captured by devices 110, 120, and 130. In such an example, devices 110, 120, 130, and 140, and primary links 111, 112, and 113, are arranged and function according to a star topology. In addition, it is appreciated that the devices described in other figures (e.g., FIGS. 1D-1G, 2A-2C, and 3A-3C) in the present application may also be one of any number of different types of devices.

Referring now to FIG. 1B, a network 105 with secondary links is shown in accordance with some embodiments. Specifically, network 105 illustrates the secondary links coupling devices 110, 120, 130, and 140 shown in network 100 of FIG. 1A. As shown, secondary link 121 couples device 110 with device 120, secondary link 122 couples device 120 with device 140, secondary link 123 couples device 120 with device 130, secondary link 124 couples device 110 with device 140, secondary link 125 couples device 130 with device 140, and secondary link 126 couples device 110 with device 130. In some embodiments, a secondary link (also referred to as a redundant link in the present application) is a link coupling two devices through which the two devices use to communicate information with each other when a primary link coupling the two devices is unavailable (e.g., the primary link fails or degrades past a threshold level).

In addition, FIG. 1B illustrates an example of devices coupled to each other through secondary links according to a full mesh topology. In some embodiments, when devices are coupled using a full mesh topology, each device is coupled to every other device (i.e., a link is established between every different pair of devices). As shown in FIG. 1B, device 110 is coupled to devices 120, 130, and 140 through secondary links 121, 126, and 124; device 120 is coupled to devices 110, 130, and 140 through secondary links 121, 123, and 122; device 130 is coupled to devices 110, 120, and 140 through secondary links 126, 123, and 125; and device 140 is coupled to devices 110, 120, and 130 through secondary links 124, 122, and 125.

Different embodiments use different methods and/or technologies for implementing secondary links 121, 122, 123, 124, 125, and 126 that couple devices 110, 120, 130, and 140. For instance, in some embodiments, devices 110, 120, 130, and 140 have the same type of, or a compatible, wireless interface (e.g., Wi-Fi, Bluetooth, Zigbee, Z-Wave, etc.) and secondary links 121, 122, 123, 124, 125, and 126 are implemented using wireless technologies associated with the wireless interfaces. As another example, devices 110, 120, 130, and 140 may have another wired interface (e.g., a secondary Ethernet interface) and secondary 1 inks 121, 122, 123, 124, 125, and 126 are implemented using wired technologies associated with the wired interfaces.

Referring now to FIG. 1C, a network 115 with primary and secondary links is shown in accordance with some embodiments. In this example, network 115 includes devices 110, 120, 130, and 140. Moreover, devices 110, 120, 130, and 140 are coupled to each other by the primary links illustrated in FIG. 1A as well as the secondary links illustrated in FIG. 1B. That is, primary link 111 couples device 110 with device 140, primary link 112 couples device 120 with device 140, primary link 113 couples device 130 with device 140, secondary link 121 couples device 110 with device 120, secondary link 122 couples device 120 with device 140, secondary link 123 couples device 120 with device 130, secondary link 124 couples device 110 with device 140, secondary link 125 couples device 130 with device 140, and secondary link 126 couples device 110 with device 130.

In some embodiments, a primary link failure may cause devices in the network to revert to a network of links with a different topology than the network of primary links. For example, a failure of primary link 111 may cause devices 110, 120, 130, and 140 to revert to primary links 112 and 113, and secondary links 121, 122, 123, 124, 125, and 126. Accordingly, the topology of such primary and secondary links is different than the topology of primary links shown in FIG. 1A. In some embodiments, devices 110, 120, 130, and 140 are previously configured (e.g., when a device is added to and/or removed from the network) to revert to the network of primary and/or secondary links while, in other embodiments, devices 110, 120, 130, and 140 are configured to revert to the network of primary and/or secondary links when primary link 111 fails.

In some embodiments, a pair of devices may use a secondary link between the pair of devices when a primary link coupling the pair of devices is unavailable (e.g., the primary link fails or degrades past a threshold level). For example, if primary link 111 fails, devices 110 and 140 may revert to utilizing secondary link 124 to communicate with each other. In this example, devices 120 and 140 still utilize primary link 112 and devices 130 and 140 still utilize primary link 113. In some embodiments, primary links 112 and 113, which are still functional, are not utilized and secondary links 122 and 125 are utilized instead. In other words, when a primary link fails, secondary links that have corresponding primary links are utilized in place of such primary links.

A pair of devices may use a secondary link between the pair of devices when primary and/or secondary links indirectly coupling the pair of devices are unavailable in some embodiments. For instance, if device 140 fails or shuts down, causing primary links 111, 112, and 113, and secondary links 122, 124, and 125 to fail, the remaining devices 110, 120, and 130 can still communicate with each other through secondary links 121, 123, and 126. That is, device 110 and 120 can communicate through secondary link 121, device 120 and 130 can communicate through secondary link 123, and device 110 and 130 can communicate through secondary link 126.

It is appreciated that a primary link failure may cause devices in the network to revert to a network of links with the same topology as the network of primary links. In some embodiments, a secondary link that corresponds to the failed primary link is utilized along with the other functional primary links. For example, if primary link 112 fails, devices 110, 120, 130, and 140 may revert to using secondary link 122 in lieu of the failed primary link 112 along with the remaining functional primary links 111 and 113. In such an example, devices 110, 120, 130, and 140 do not utilize secondary links 121, 123, 124, 125 and 126 even though such links are still functional. As such, the same topology as the network topology of primary link 111, 112, and 113 shown in FIG. 1A is maintained. In some embodiments, a secondary link that corresponds to the failed primary link is utilized along with secondary links that correspond to other functional primary links. For example, if primary link 112 fails, devices 110, 120, 130, and 140 revert to using secondary links 122, 124, and 125. That is, devices 110, 120, 130, and 140 do not utilize primary links 111 and 113, and secondary links 121, 123, and 126 even though such links are functional. This way, the same topology as the network topology of primary link 111, 112, and 113 shown in FIG. 1A is maintained. In some embodiments, devices 110, 120, 130, and 140 are previously configured (e.g., when a device is added to and/or removed from the network) to revert to the network of primary and/or secondary links. In other embodiments, devices 110, 120, 130, and 140 are configured to revert to the network of primary and/or secondary links when primary link 112 fails.

Referring now to FIG. 1D, a new device added to network 100 is shown in accordance with some embodiments. In particular, network 135 includes new device 150. In some embodiments, device 150 is added to network 100 by powering up device 150, bringing device 150 within range of network 100, establishing primary link 114 (e.g., plugging an Ethernet cable that is coupled to device 140 in an Ethernet interface of device 150, etc.), powering up a network device (e.g., switch, hub, router, etc.) that couples to device 150 and device 140, etc. As shown, primary link 114 couples device 150 with device 140. Primary link 114 is implemented in the same or similar manner as primary links 111, 112, and 113 described above by reference to FIG. 1A.

Referring now to FIG. 1E, a network 145 with secondary links of network 135 is shown in accordance with some embodiments. Specifically, network 145 illustrates the secondary links coupling devices 110, 120, 130, 140, and 150 shown in network 135 of FIG. 1D. In this example, primary links (not shown) couple devices 110, 120, 130, 140, and 150 in a manner similar to that described above by reference to FIG. 1D. In addition to secondary links 121, 122, 123, 124, 125, and 126 that couple devices 110, 120, 130, and 140, FIG. 1E shows that secondary link 127 couples device 110 with device 150, secondary link 128 couples device 140 with device 150, secondary link 129 couples device 130 with device 150, and secondary link 131 couples device 120 with device 150. Secondary links 127, 128, 129, and 131 are implemented in the same or similar manner as secondary links 121, 122, 123, 124, 125, and 126 described above by reference to FIG. 1B.

Similar to FIG. 1B, FIG. 1E illustrates an example of devices coupled to each other through secondary links according to a full mesh topology. For this example, devices 110, 120, 130, 140, and 150 are configured to establish secondary links 127, 128, 129, and 131 upon the addition of device 150 to network 135 in order to maintain a full mesh topology of secondary links. In other words, devices 110, 120, 130, 140, and 150 are configured to established secondary links with every other device.

Referring now to FIG. 1F, a device removed from network 135 is shown in accordance with some embodiments. As illustrated, network 155 includes devices 110, 130, 140, and 150 as device 120 has been removed. As a result, primary link 112 no longer exists. In some embodiments, device 120 is removed from network 135 by powering down device 120, failure of links (e.g., primary and/or secondary links) of device 120, powering down a network device (e.g., switch, hub, router, etc.) that couples device 120 to the network 135, etc.

Referring now to FIG. 1G, a network 165 with secondary links is shown in accordance with some embodiments. Specifically, network 165 illustrates the secondary links coupling devices 110, 130, 140, and 150 shown in network 135 of FIG. 1F. In this example, primary links (not shown) couple devices 110, 130, 140, and 150 in a manner similar to that described above by reference to FIG. 1F. As shown, network 165 includes the same secondary links illustrated in FIG. 1E except for secondary links 121, 122, 123, and 131 because device 120 has been removed.

Similar to FIGS. 1B and 1E, FIG. 1G illustrates an example of devices coupled to each other through secondary links according to a full mesh topology. As shown, secondary links 121, 122, 123, and 131 no longer exist as device 120 has been removed. However, the remaining secondary links 124, 125, 126, 127, 128, and 129 still couple devices 110, 130, 140, and 150 according to a full mesh topology. For this example, devices 110, 130, 140, and 150 are configured to establish secondary links 124, 125, 126, 127, 128, and 129 and not establish secondary links 121, 122, 123, and 131, upon the removal of device 150 to network 135 in order to maintain a full mesh topology of secondary links. In other words, devices 110, 120, 130, 140, and 150 are configured to established secondary links with every other device.

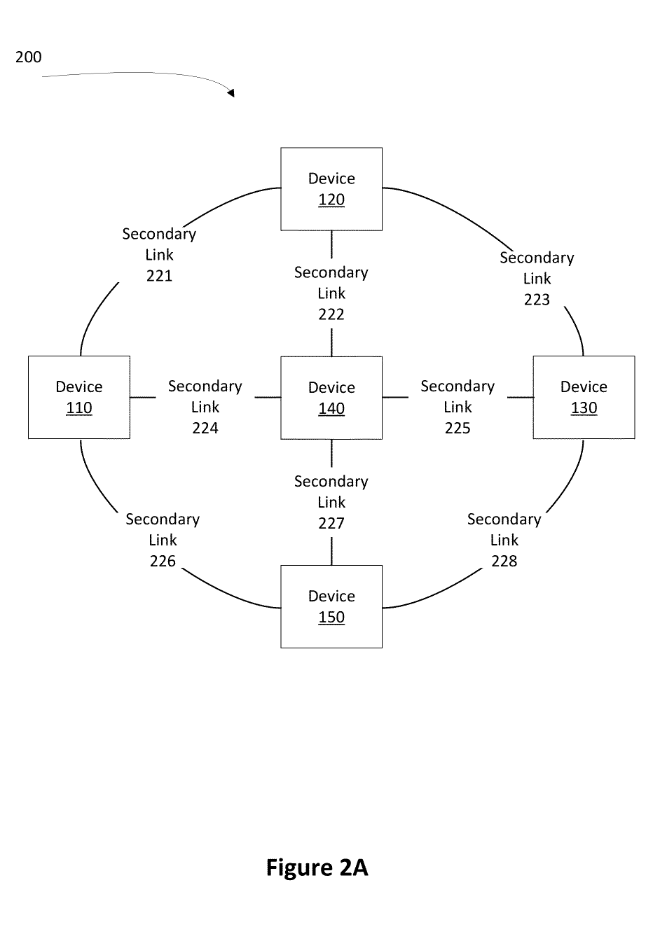

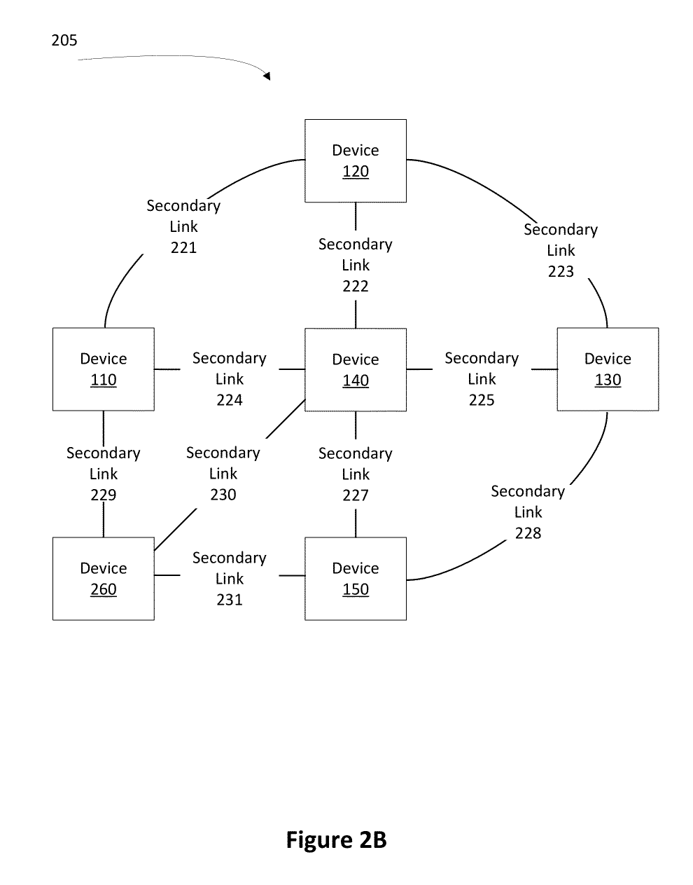

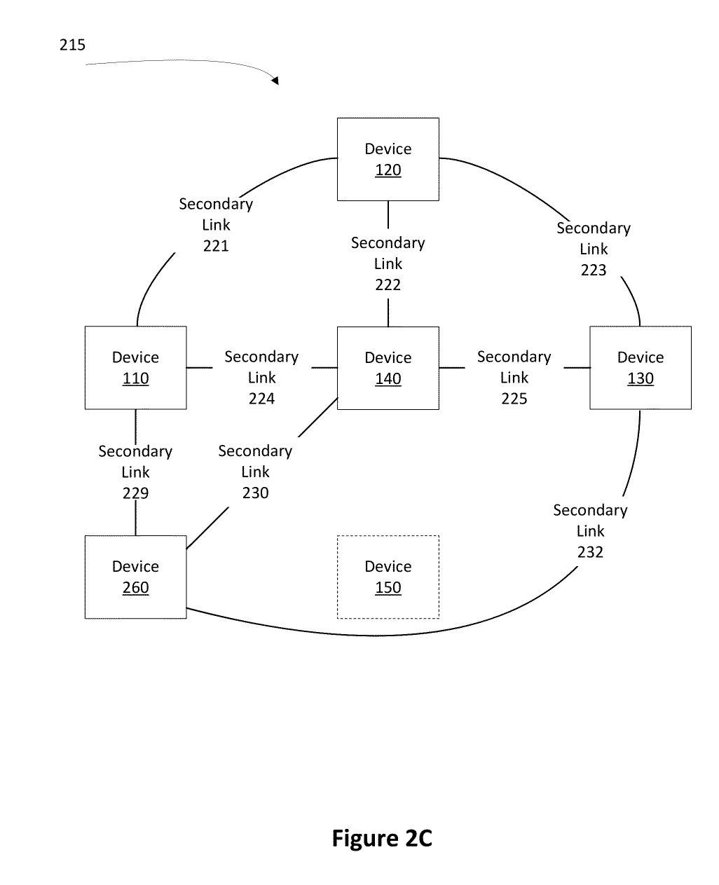

FIGS. 2A-2C show examples of a network with redundant links established based on another mesh topology in accordance with some embodiments. In particular, FIGS. 2A-2C illustrate a network with redundant links established based on a partial mesh topology. Referring now to FIG. 2A, a network 200 with secondary links is shown in accordance with some embodiments. In this example, network 200 includes devices 110, 120, 130, 140, and 150, and primary links (not shown) couple devices 110, 120, 130, 140, and 150 in a manner similar to that described above by reference to FIG. 1D. As shown, secondary link 221 couples device 110 with device 120, secondary link 222 couples device 120 with device 140, secondary link 223 couples device 120 with device 130, secondary link 224 couples device 110 with device 140, secondary link 225 couples device 130 with device 140, secondary link 226 couples device 110 with device 150, secondary link 227 couples device 140 with device 150, and secondary link 228 couples device 130 with device 150. Secondary links 221, 222, 223, 224, 225, 226, 227, and 228 are implemented in the same or similar manner as secondary links 121, 122, 123, 124, 125, and 126 described above by reference to FIG. 1B.

In addition, FIG. 2A illustrates an example of devices coupled to each other through secondary links according to a partial mesh topology. In some embodiments, when devices are coupled using a partial mesh topology, at least two devices are coupled to more than one other device. In this example, devices 110, 120, 130, 140, and 150 are coupled to other adjacent devices (e.g., devices that are within a threshold distance). As shown, device 110 is coupled to devices 120, 140, and 150 through secondary links 221, 224, and 226; device 120 is coupled to devices 110, 130, and 140 through secondary links 221, 223, and 222; device 130 is coupled to devices 120, 140, and 150 through secondary links 223, 225, and 228; device 140 is coupled to devices 110, 120, 130, and 150 through secondary links 224, 222, 225, and 227; and device 150 is coupled to devices 110, 130, and 140 through secondary links 226, 228, and 227. For this example, devices 110, 120, 130, 140, and 150 are configured to establish secondary links 221, 222, 223, 224, 225, 226, 227, and 228 in the same manner as that described above by reference to FIGS. 1A-1G (e.g., upon failure of a link and/or link, upon addition of a device to the network, upon removal of a device from the network, etc.).

It is appreciated that a partial mesh topology is used in some embodiments to couple devices with secondary links when the methods and/or technologies used to establish secondary links is limited by the distance between devices (e.g., Bluetooth, Zigbee, Wi-Fi, Ethernet, Z-Wave, etc.) and/or by the resources of the devices (e.g., increasing the number of secondary links for a device to manage increases the amount of resources utilized by the device). For instance, a wireless technology used to implement secondary links to couple devices 110, 120, 130, 140, and 150 and/or the relative placement of devices 110, 120, 130, 140, and 150 may allow each device to establish secondary links to the device's neighboring or adjacent devices, as illustrated in FIG. 2A.

Even though in a partial mesh topology at least one device is not directed coupled to every other device via secondary links, such devices are, however, directly or indirectly coupled to every other device via secondary links. That is, the devices are still able to communicate with every other device through a path of one or more secondary links and/or primary links. For example, a secondary link does not directly couple device 110 with device 130, but device 110 can still communicate with device 130 through secondary links 121 and 123, secondary links 124 and 125, secondary links 127 and 129, primary link 111 and secondary link 225, or secondary link 224 and primary link 113. In some embodiments, device 110 can communicate with device 130 through any number of the different paths of secondary and/or primary links.

Referring now to FIG. 2B, a new device added to network 200 is shown in accordance with some embodiments. In particular, network 205 includes new device 260 as well as devices 110, 120, 130, 140, and 150. For this example, device 260 is added to network 200 in the same or similar fashion as the addition of device 150 described above by reference to in FIG. 1D. Also in this example, primary links (not shown) couple devices 110, 120, 130, 140, and 150 in a manner similar to that described above by reference to FIG. 1D, and a primary link (not shown) couples device 260 with device 140.

In some embodiments, some or all devices are reconfigured to establish secondary links upon an addition of a new device. Referring to FIG. 2B as an example, devices 110, 140, and 150 are reconfigured to establish secondary links when device 260 is added. As illustrated, devices 110 is reconfigured to establish secondary link 229 instead of secondary link 226, device 140 is reconfigured to also establish secondary link 230, and device 150 is reconfigured to establish secondary link 231 instead of secondary link 226. Secondary links 229, 230, and 231 are implemented in the same or similar manner as secondary links 121, 122, 123, 124, 125, and 126 described above by reference to FIG. 1B.

Similar to FIG. 2A, FIG. 2B illustrates an example of devices coupled to each other through secondary links according to a partial mesh topology where devices are coupled to other adjacent devices. As shown, device 110 is coupled to device 260 (through secondary link 229) instead of device 150, device 150 is coupled to device 260 (through secondary link 231) instead of device 110, and device 140 is coupled to device 260 (through secondary link 230). Other possible configurations of secondary links are possible in other embodiments. For instance, devices 110 and 150 are considered adjacent devices in some embodiments and a secondary link is established between device 110 and device 150. As another example, devices 140 and 260 are not considered adjacent devices in some embodiments and secondary link 230 is not established.

Referring now to FIG. 2C, a device removed from network 205 is shown in accordance with some embodiments. As shown, network 215 includes devices 110, 120, 130, 140, and 260 since device 150 has been removed. For this example, device 150 is removed from network 205 in the same or similar manner as the removal of device 120 described above by reference to in FIG. 1F. Also in this example, primary links (not shown) couple devices 110, 120, 130, 140, and 260 in a manner similar to that described above by reference to FIGS. 1D and 2B. FIG. 2C further illustrates that network 215 includes the same secondary links illustrated in FIG. 2B except for secondary links 227, 228, and 231 because device 150 has been removed. Additionally, a secondary link 232 is established between device 130 and device 260.

In some embodiments, some or all devices are reconfigured to establish secondary links upon a removal of a device. Referring to FIG. 2C as an example, devices 130, 140, and 260 are reconfigured to establish secondary links when device 150 is removed. As shown, device 140 is reconfigured to not establish secondary links 227, device 130 is reconfigured to establish secondary link 232 instead of secondary link 228, and device 260 is reconfigured to establish secondary link 232 instead of secondary link 231. Secondary link 232 is implemented in the same or similar manner as secondary links 121, 122, 123, 124, 125, and 126 described above by reference to FIG. 1B.

The figures described above illustrate examples of redundant links arranged according to full mesh and partial mesh topologies. It is appreciated that redundant links may be arranged differently in different embodiments. For example, redundant links may be arranged to mirror the primary links in the network in some embodiments. Referring to FIG. 2A as an example, the redundant links may include secondary links 222, 224, 225, and 227, which mirror the primary links 112, 111, 113, and 114, respectively, shown in FIG. 1D.

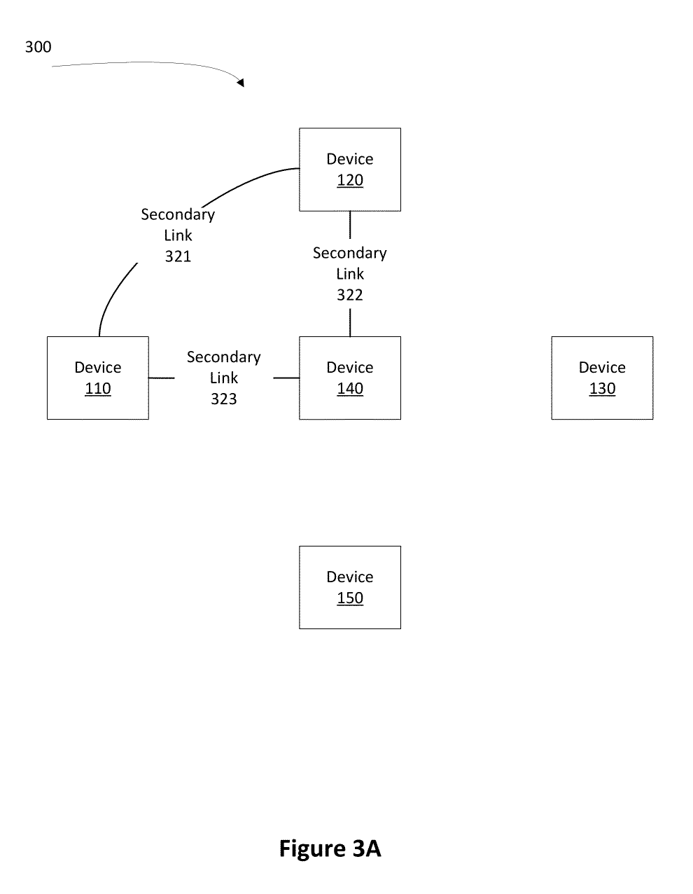

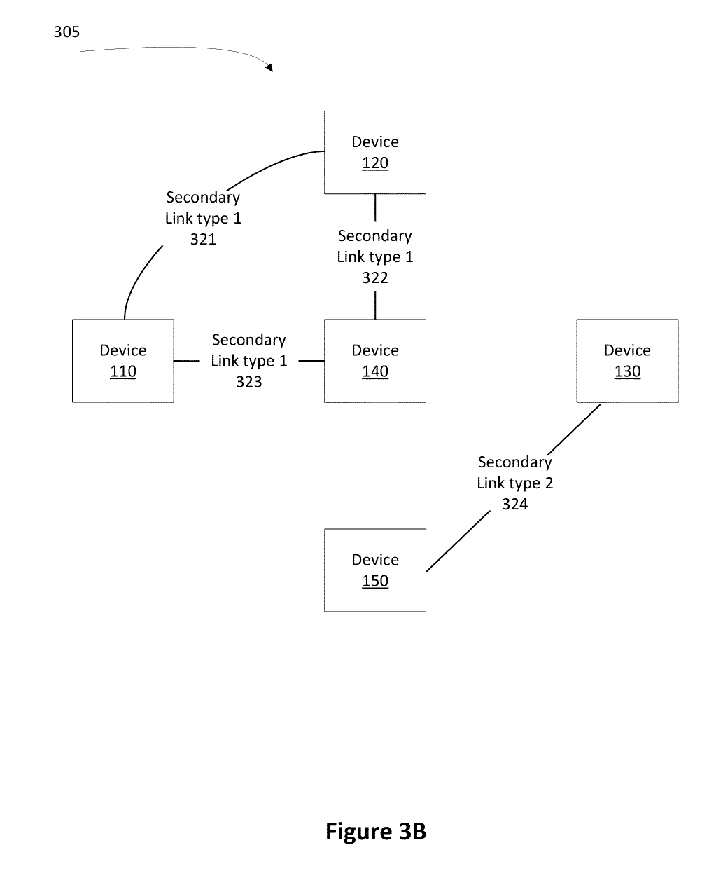

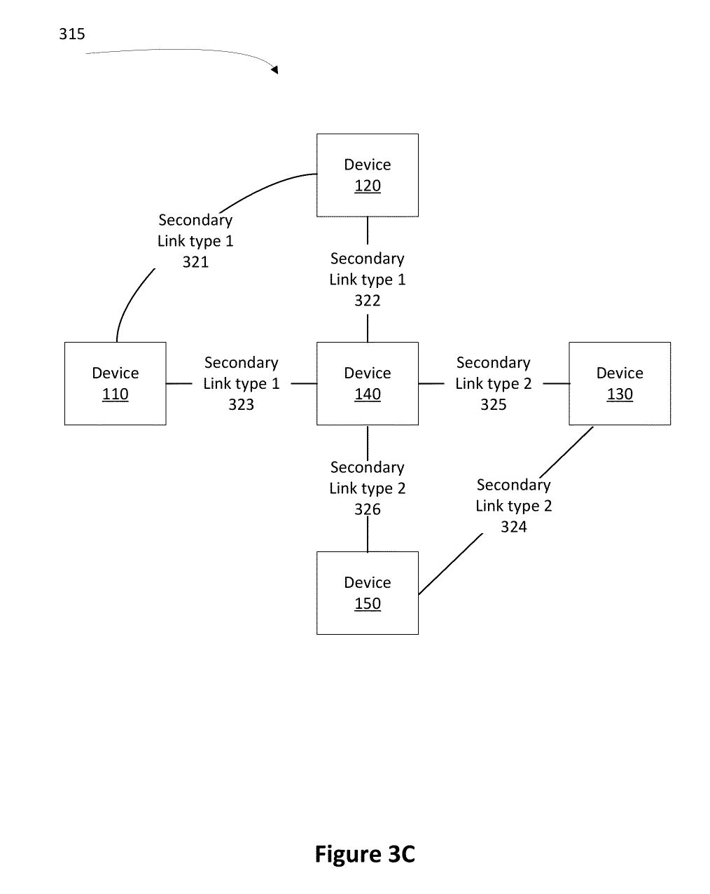

FIGS. 3A-3C show examples of a network with different configurations of redundant links in accordance with some embodiments. Referring now to FIG. 3A, a network 300 with a portion of devices coupled with secondary links is shown in accordance with some embodiments. In this example, network 300 includes devices 110, 120, 130, 140, and 150, and primary links (not shown) couple devices 110, 120, 130, 140, and 150 in a manner similar to that described above by reference to FIG. 1D. As shown, secondary link 321 couples device 110 with device 120, secondary link 322 couples device 120 with device 140, and secondary link 323 couples device 110 with device 140. Secondary links 321, 322, and 323 are implemented in the same or similar manner as secondary links 121, 122, 123, 124, 125, and 126 described above by reference to FIG. 1B.

In some embodiments, a primary link failure may cause devices in the network to revert to a network of links with a different topology than the network of primary links. For example, a failure of primary link 111 in FIG. 1D may cause devices 110, 120, 130, 140, and 150 to revert to primary links 112, 113, and 114 and secondary links 321, 322, and 323. Accordingly, the topology of such primary and secondary links is different than the topology of primary links shown in FIG. 1D.

In some embodiments, a subset of devices may have the same or compatible capabilities to establish secondary links with each other. Referring to FIG. 3A as an example, devices 110, 120, and 140 have compatible wireless interfaces (e.g., Wi-Fi, Bluetooth, Zigbee, Z-Wave, etc.) while devices 130 and 150 do not. As such, devices 110, 120, and 140 are coupled to each other through secondary links 321, 322, and 323. While devices 130 and 150 are not coupled to any other devices via secondary links, devices 130 and 150 can still communicate with other devices through primary links (not shown).

In some embodiments where a subset of devices have the same or compatible capabilities to establish secondary links with each other, a pair of devices may use a secondary link between the pair of devices when a primary link coupling the pair of devices is unavailable (e.g., the primary link fails or degrades past a threshold level). For example, if primary link 111 fails, devices 110 and 140 may revert to utilizing secondary link 323 to communicate with each other. In this example, devices 120 and 140 still utilize primary link 112, devices 130 and 140 still utilize primary link 113, and devices 140 and 150 still utilize primary link 114. In some embodiments, primary link 112, which are still functional, is not utilized, and secondary link 322 is utilized instead. In other words, when a primary link fails, secondary links that have corresponding primary links are utilized in place of such primary links and other remaining primary links are still utilized.

It is appreciated that a primary link failure may cause devices in the network to revert to a network of links with the same topology as the network of primary links. In some embodiments, a secondary link that corresponds to the failed primary link is utilized along with the other functional primary links. For example, if primary link 112 fails, devices 110, 120, 130, and 140 may revert to using secondary link 322 in lieu of the failed primary link 112 along with the remaining functional primary links 111, 113, and 114. In such an example, devices 110, 120, 130, and 140 do not utilize secondary links 321 and 323 even though such links are still functional. As such, the same topology as the network topology of primary link 111, 112, 113, and 114 shown in FIG. 1D is maintained. In some embodiments, a secondary link that corresponds to the failed primary link is utilized along with secondary links that correspond to other functional primary links while maintaining the same topology as the topology of primary links.

In some embodiments, different sets of devices may have different, compatible capabilities to establish secondary links with each other. Referring now to FIG. 3B as an example, a network 305 with different sets of devices coupled with secondary links is shown in accordance with some embodiments. As shown, devices 110, 120, and 140 are coupled to each other through secondary links 321, 322, and 323, and devices 130 and 150 are coupled to each other through secondary link 324. Secondary link 324 is implemented in the same or similar manner as secondary links 121, 122, 123, 124, 125, and 126 described above by reference to FIG. 1B.

In this example, devices 110, 120, and 140 establish secondary links 321, 322, and 323 using a first type of method and/or technology (e.g., Bluetooth) while devices 130 and 150 establish secondary link 324 using a second, different type of method and/or technology (e.g., Zigbee). In this manner, devices with the same or compatible capabilities are able to establish secondary links between each other using their respective compatible methods and/or technologies.

In some embodiments, a device may have multiple different capabilities to establish secondary links with other devices. Referring now to FIG. 3C as an example, a network 315 with a device that establishes secondary links with different sets of devices is shown in accordance with some embodiments. As shown, devices 110, 120, and 140 are coupled through secondary links 321, 322, and 323, and devices 130, 140, and 150 are coupled through secondary links 324, 325, and 326. Secondary links 325 and 326 are implemented in the same or similar manner as secondary links 121, 122, 123, 124, 125, and 126 described above by reference to FIG. 1B.

In this example, device 140 establishes secondary links 322 and 323 using a first type of method and/or technology (e.g., Bluetooth) and also establishes secondary links 325 and 326 using a second, different type of method and/or technology (e.g., Zigbee). Thus, device 140 utilizes its multiple, different capabilities to establish secondary links in order to simultaneously couple to devices with different, but compatible with capabilities of device 140.

Many of the figures described above show a network with secondary links (e.g., FIGS. 1B, 1E, 1G, 2A-2C, and 3A-3C). One of ordinary skill in the art will understand that the primary links coupling the devices have been omitted for the purpose of simplicity and explanation. In some embodiments, the devices are previously configured (e.g., when a device is added to and/or removed from the network) to revert to the network of primary and/or secondary links. In other embodiments, the devices are configured to revert to the network of primary and/or secondary links when a link and/or device fails.

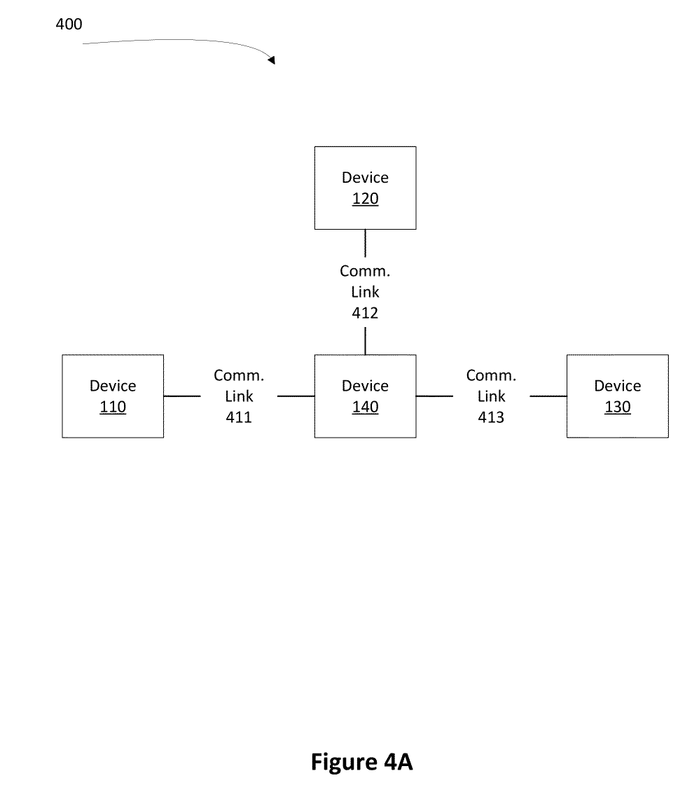

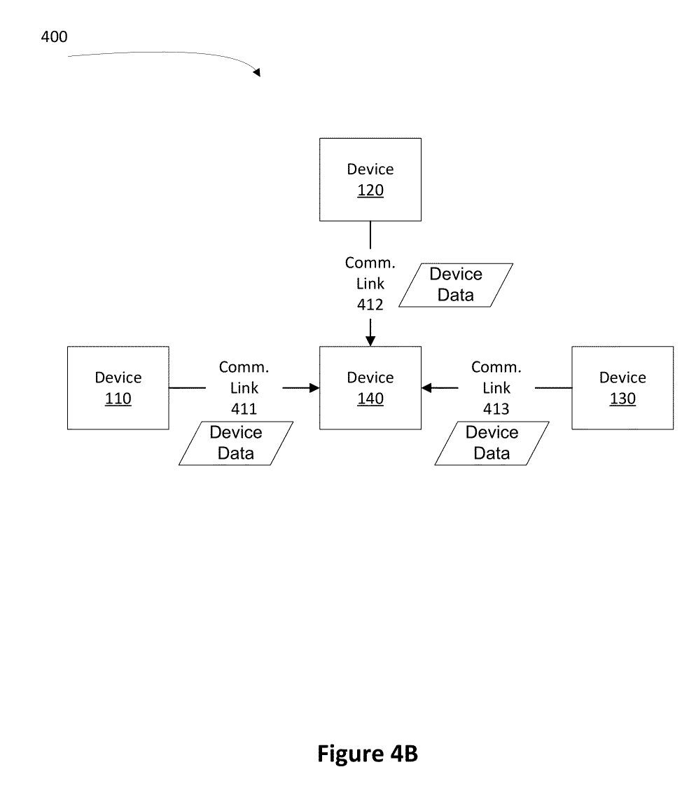

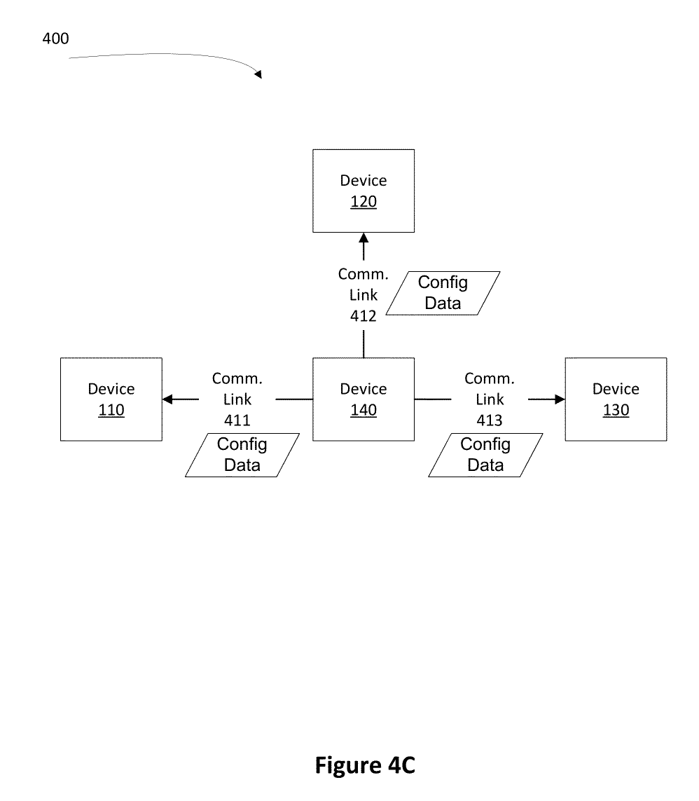

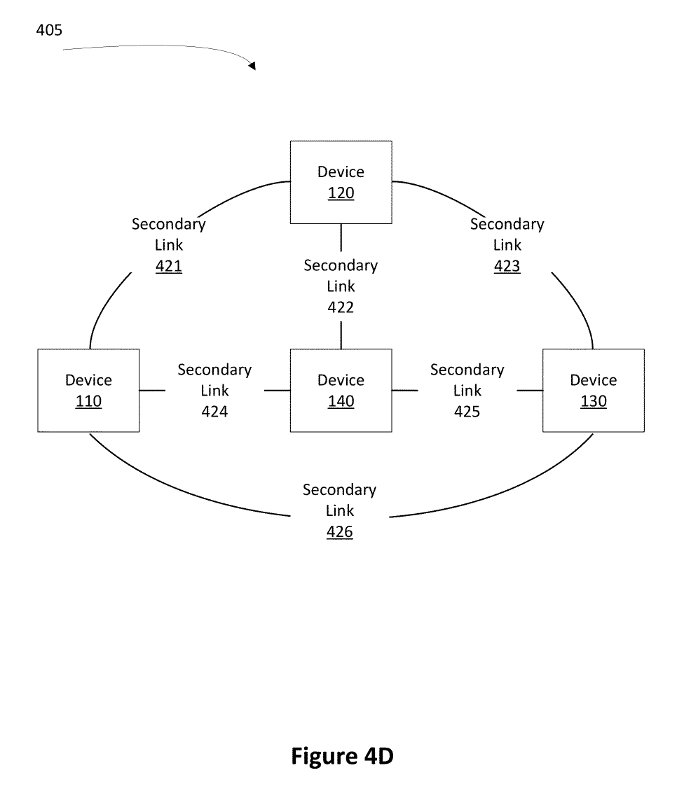

Different embodiments use different methodologies to establish secondary, redundant links between devices. FIGS. 4A-4D show an example of establishing redundant links for a network in accordance with some embodiments. In particular, FIGS. 4A-4D illustrate a device designated to handle the configuration of devices in order to establish redundant links. Referring now to FIG. 4A, a network 400 with communication links is shown in accordance with some embodiments. FIG. 4A is similar to the previously described FIG. 1A except that devices 110, 120, and 130 are coupled to device 140 through communication links 411, 412, and 413. In some embodiments, communication links 411, 412, and 413 are similar to primary links 111, 112, and 113 described above by reference to FIG. 1A. In other words, devices 110, 120, 130, and 140 communicate through primary links in order to identify devices with the same or compatible technology, and determine the topology of (e.g., full mesh, partial mesh, etc.) and configurations for establishing secondary links among the identified devices using such technology upon a link failure.

Referring now to FIG. 4B, a device receiving information from other devices is shown in accordance with some embodiments. In this example, device 140 is designated to handle the configuration of devices 110, 120, 130, and 140 in order to establish secondary links. As shown, devices 110, 120, and 130 are sending to device 140 device data through communication links 411, 412, and 413. In some embodiments, device data may include a device's device type (e.g., sensor device, image capture device, mobile device, computing device, network device, etc.), communication capabilities (e.g., Bluetooth, Zigbee, Wi-Fi, Ethernet, Z-Wave, etc.), geolocation, and bandwidth capabilities (e.g., 10 Mbit/s, 100 Mbit/s, 1 Gbit/s, etc.), among other information associated with establishing secondary links.

Although FIG. 4B illustrates devices 110, 120, and 130 sending device data to device 140 at the same time, it is appreciated that devices 110, 120, and 130 can send to device 140 their device data asynchronously. For instance, in some embodiments, devices 110, 120, 130 may each send device data to device 140 upon powering up and/or upon a detection of a change of its own device capabilities, and/or upon being added to the network, etc. Additionally, devices 110, 120, and 130 may send device data to device 140 at defined intervals in some embodiments.

While FIG. 4B illustrates one way that devices 110, 120, 130 share device data with device 140, it is appreciated that devices may share device data in any number of different ways. For instance, in some embodiments, the devices 110, 120, 130, and 140 use an extension of a link layer discovery protocol (LLDP) to share device data with each other. Other methods and/or technologies may be used in other embodiments.

In some embodiments, devices share device data with each other based on a discovery, announcement, multicast, and/or broadcast protocol of a technology used to establish secondary links. For example, devices 110, 120, 130, and 140 with the same or compatible technology (e.g., a Bluetooth technology, Wi-fi technology, or Zigbee technology, etc.), may use a discovery, announcement, multicast, and/or broadcast protocol of such technology to share device data with each other. This way, the devices with the same or compatible technology may determine the topology of secondary links based on the shared device data and determine the configuration to use to establish secondary links using such technology upon a link and/or device failure.

Referring now to FIG. 4C, a device transmitting configuration information to other devices is shown in accordance with some embodiments. Similar to FIG. 4B, device 140 is designated to handle the configuration of devices 110, 120, 130, and 140 in order to establish secondary links in this example. As shown, device 140 is sending to devices 110, 120, and 130 configuration data through communication links 411, 412, and 413. In some embodiments, configuration data may include the communication capability (e.g., Bluetooth, Zigbee, Wi-Fi, Ethernet, Z-Wave, etc.) to use to establish secondary links, devices with which secondary links are to be established, and bandwidth capabilities (e.g., 10 Mbit/s, 100 Mbit/s, 1 Gbit/s, etc.) of secondary links established with devices, among other information associated with configuring a device to establish secondary links with other devices. In some embodiments, device 140 determines a configuration for each of the devices 110, 120, and 130 and itself based on the device data of devices 110, 120, and 130 as well as its own device data. Also, device 140 determines its own configuration based on the device data of devices 110, 120, 130, and its own device data.

Referring now to FIG. 4D, a network 405 with secondary links is shown in accordance with some embodiments. Specifically, FIG. 4D illustrates network 405 after a link and/or device failure. In response to such failure, devices 110, 120, 130, and 140 configured their own respective devices based on the configuration data determined by device 140 in order to establish secondary links between each other. As shown, network 405 is similar to network 105 described above by reference to FIG. 1B. That is, devices 110, 120, 130, and 140 are coupled via secondary links 421, 422, 423, 424, 425, and 426 according to a full mesh topology. Secondary links 421, 422, 423, 424, 425, and 426 are implemented in the same or similar manner as secondary links 121, 122, 123, 124, 125, and 126 described above by reference to FIG. 1B.

In some embodiments, when a link associated with a device fails, the device notifies other devices (e.g., other impacted devices or all of the other devices) to revert to using secondary and/or primary links to communicate. The device may notify the other devices to utilize secondary links, in some embodiments, while the device may notify devices impacted by the failure, in other embodiments. When the failure occurs, the device notifies other devices in different ways in different embodiments. For example, the device sends a signal to other devices via the technology used to establish secondary links and/or the technology used to establish primary links. The signal notifies the other devices to revert to using secondary and/or primary links.

While FIG. 4D shows secondary links established between devices 110, 120, 130, and 140 in one particular configuration, it is appreciated that secondary links may be established between devices 110, 120, 130, and 140 in any number of different configurations. For example, devices 110, 120, and 130 may be configured to establish secondary links between each other, but not with device 140. Other configurations (e.g., configurations similar to those described above by reference to FIGS. 3A-3C) are possible.

It is appreciated that devices are configured to establish secondary links at different times in different embodiments. For instance, devices are configured to establish secondary links upon detecting that a primary link has failed (i.e., devices are configured/secondary links are established on the fly) in some embodiments. In other embodiments, devices are configured before detection of a primary link failure (i.e., devices are preconfigured/secondary links are pre-established). Particular events (e.g., an addition of a device, a removal of a device, a change in a device's capabilities) may trigger devices to be reconfigured in some such other embodiments.

FIGS. 4A-4D illustrate a device (device 140 in that example) designated to handle configuration of devices. It is appreciated that any of the other devices 110, 120, and 130 may be designated to handle configuration of devices in the same or similar manner as that described by reference to device 140 in FIGS. 4A-4D. In some embodiments, the device designated to handle configuration of devices is not one of the devices 110, 120, 130, and 140. For example, a separate device that is dedicated to handle configuration of devices in the same or similar manner as that described by reference to device 140 in FIGS. 4A-4D is used.

In some embodiments, a device may receive device data from all the other devices and determine its own configuration for establishing secondary links based on all the devices' device data (including its own device data). Referring to FIG. 4B as an example, device 110 receives device data from devices 120, 130, and 140; device 120 receives device data from devices 110, 130, and 140; device 130 receives device data from devices 110, 120, and 140; and device 140 receives device data from devices 110, 120, and 130. Devices 110, 120, and 130 receive device data from the other devices in the same or similar manner that device 140 receives device data from devices 110, 120, and 130. It is appreciated that devices 110, 120, 130, and 140 may receive device data from other devices directly and/or indirectly through any number of different technologies (e.g., technology used for primary links, technology used for secondary links, technology not used for primary nor secondary links, any combination thereof, etc.). Upon receiving device data from all the other devices, the devices 110, 120, and 130 determines its own configuration for establishing secondary links in the same or similar manner that device 140 determined its own configuration. In this example, devices 110, 120, 130, and 140 have the same logic for determining configurations and, thus, would arrive at the same determination independently. Accordingly, devices 110, 120, 130, and 140 are configured in an ad hoc manner in this example. It is appreciated that the methodologies described above related to a device determining its own configuration for establishing secondary links based on device data may be implemented by any of the embodiments and examples described herein.

In some embodiments, a device may receive device data from adjacent or neighboring devices and determine its own configuration for establishing secondary links based on the adjacent or neighboring devices' device data (including its own device data). Referring back to FIG. 2A as an example, device 110 may determine its configuration based on its own device data and device data received from devices 120, 140, and 150; device 120 may determine its configuration based on its own device data and device data received from devices 110, 130, and 140; device 130 may determine its configuration based on its own device data and device data received from devices 120, 140, and 150; device 140 may determine its configuration based on its own device data and device data received from devices 110, 120, 130, and 140; and device 150 may determine its configuration based on its own device data and device data received from devices 110, 130 and 140.

It is appreciated that the embodiments and examples described above in FIGS. 4A-4D may be applicable to other embodiments and example described in this application. For instance, the devices described in FIGS. 1A-1G, 2A-2C, and 3A-3C may share their device data in any manner described above in order to determine the topology of secondary links and configure the devices to establish redundant links upon a failure of a link and/or device in the network.

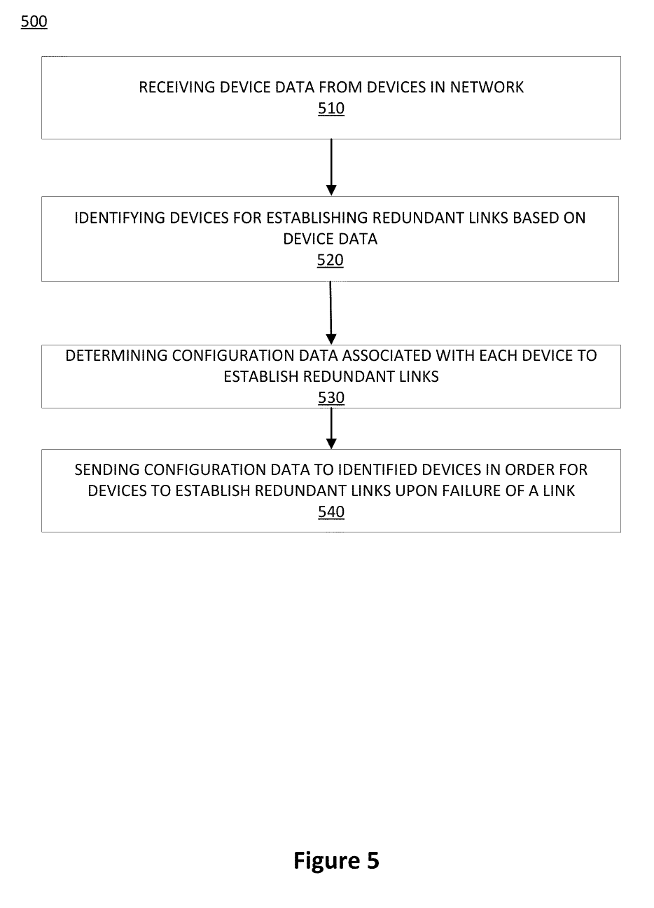

FIG. 5 shows an exemplary flow diagram for creating configurations for devices to establish redundant links in accordance with some embodiments. In some embodiments, a device (e.g., device 140 described above by reference to FIG. 4A-4D) designated to handle the configuration of devices in order to establish redundant links performs the operations described in FIG. 5. At step 510, device data from devices in a network is received. As mentioned above, device data may include a device's device type, communication capabilities, geolocation, bandwidth capabilities, etc. In some embodiments, the received device data is stored (e.g., in a storage) for later retrieval. Referring to FIG. 4B as an example, device 140 is configured to store the device data of devices 110, 120, and 130 upon receiving the device data.

At step 520, devices for establishing redundant links are identified based on device data. Referring to FIG. 4B as an example, when device 140 receives device data from devices 110, 120, and 130, device 140 determines which of devices 110, 120, 130, and itself, have the capabilities to establish redundant links with each other. In some embodiments, different sets of devices with different, compatible capabilities are identified.

Upon identifying devices for establishing redundant links, configuration data associated with each device to establish redundant links are determined at step 530. In some embodiments, configuration data for devices to establish redundant links are determined for each identified device based on the device data of the identified devices. Referring to FIG. 4C as an example, device 140 determines a configuration for each of the devices 110, 120, and 130 based on the device data of devices 110, 120, and 130 as well as its own device data. In some embodiments that store device data, as mentioned above by reference to step 520, the determination of configuration data involves retrieving the device data (e.g., from a storage). Referring to FIG. 4C as an example, device 140 retrieves (e.g., from device 140) the device data of each of the devices 110, 120, and 130 upon receiving the device data.

At step 540 configuration data is sent to the identified devices in order for the identified devices to establish redundant links with each other upon failure of a link. Specifically, when a link failure occurs, the identified devices use the configuration data to configure themselves to establish redundant links. As explained above, configuration data may include the communication capability to use to establish secondary links, devices with which secondary links are to be established, bandwidth capabilities of secondary links established with devices, etc.

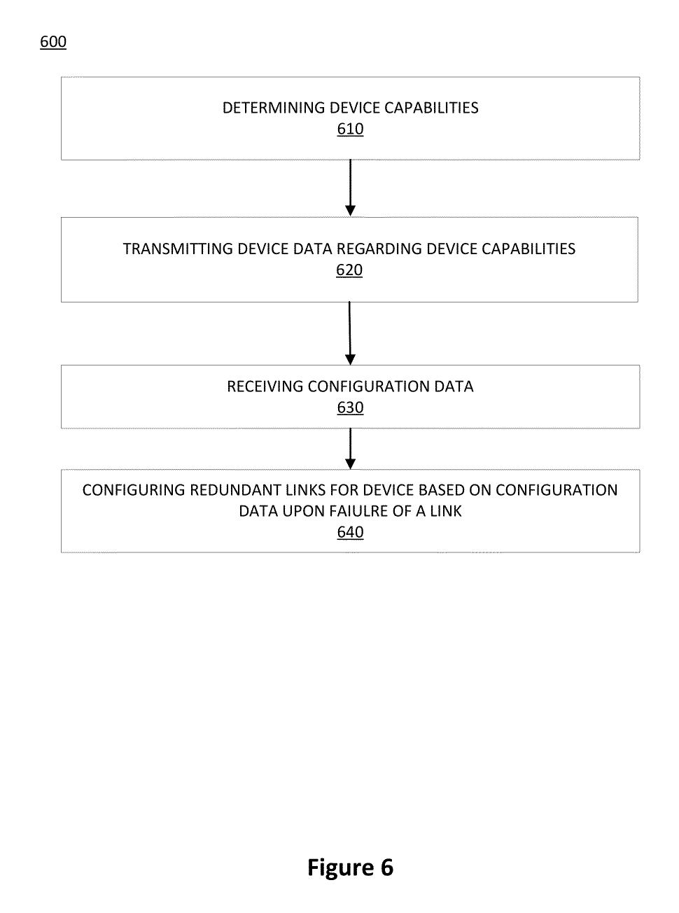

FIG. 6 shows an exemplary flow diagram for configuring a device to establish redundant links in accordance with some embodiments. In some embodiments, every device (e.g., devices 110, 120, 130, and 140 described above by reference to FIG. 4A-4D) that establishes secondary links performs the operations described in FIG. 6. At step 610, device capabilities are determined Referring to FIG. 4A as an example, each of the devices 110, 120, 130, and 140 performs step 610 upon powering up, upon coming within range of network 400, upon a detection of a change of its own device capabilities, and/or at defined intervals.

At step 620, device data regarding device capabilities is transmitted. Referring to FIG. 4B as an example, device 110 performs step 620 by transmitting its device data to device 140 through communication link 411, device 120 performs step 620 by transmitting its device data to device 140 through communication link 412, and device 130 performs step 620 by transmitting its device data to device 140 through communication link 413. In some embodiments, device 140, which is designated to handle the configuration of devices 110, 120, and 130, performs step 620 by storing (e.g., in a storage) on device 140 its own determined device capabilities.

At step 630, configuration data is received. Referring to FIG. 4C as an example, device 110 performs step 630 by receiving configuration data from device 140 through communication link 411, device 120 performs step 630 by receiving configuration data from device 140 through communication link 412, and device 130 performs step 630 by receiving configuration data from device 140 through communication link 413. In some embodiments, device 140, which is designated to handle the configuration of devices 110, 120, and 130, performs step 630 by retrieving (e.g., from a storage) on device 140 its own device data along with the device data of devices 110, 120, and 130, and determining its own configuration data based on the device data of devices 110, 120, and 130 and its own device data. In some embodiments that employ an ad hoc configuration of devices, as described above by reference to FIGS. 4A-4D, a device performs step 630 by determining its own configuration based on the device data of other devices as well as its own, storing the configuration, and/or retrieving the configuration.

At step 640, redundant links are configured based on the configuration data. Referring to FIG. 4D as an example, each of the devices 110, 120, 130, and 140 performs step 640 upon failure of a link. In particular, a failure of a primary link may cause device 110 to configure itself to establish secondary links 421, 424, and 426; device 120 to configure itself to establish secondary links 421, 422, and 423; device 130 to configure itself to establish secondary links 423, 425, and 426; and device 140 to configure itself to establish secondary links 422, 424, and 425.

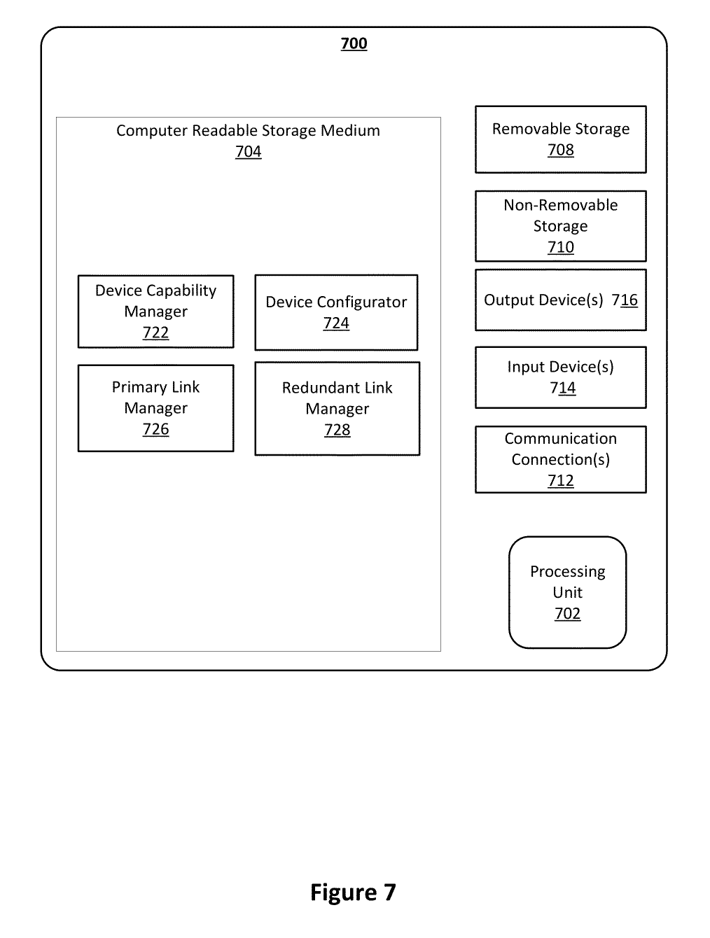

Referring now to FIG. 7, a block diagram of an exemplary computer system in accordance with some embodiments is shown. With reference to FIG. 7, an exemplary system module for implementing embodiments includes a general purpose computing system environment, such as computing system environment 700. Computing system environment 700 may include, but is not limited to, servers, switches, routers, desktop computers, laptops, tablets, mobile devices, and smartphones. In its most basic configuration, computing system environment 700 typically includes at least one processing unit 702 and computer readable storage medium 704. Depending on the exact configuration and type of computing system environment, computer readable storage medium 704 may be volatile (such as RAM), non-volatile (such as ROM, flash memory, etc.) or some combination of the two. Portions of computer readable storage medium 704 when executed facilitate the determination of device capabilities, the determination of configuration data, and the configuration of devices in order to establish redundant links (e.g., processes 500 and 600).

Additionally, in various embodiments, computing system environment 700 may also have other features/functionality. For example, computing system environment 700 may also include additional storage (removable and/or non-removable) including, but not limited to, magnetic or optical disks or tape. Such additional storage is illustrated by removable storage 708 and non-removable storage 710. Computer storage media includes volatile and nonvolatile, removable and non-removable media implemented in any method or technology for storage of information such as computer readable instructions, data structures, program modules or other data. Computer readable medium 704, removable storage 708 and nonremovable storage 710 are all examples of computer storage media. Computer storage media includes, but is not limited to, RAM, ROM, EEPROM, flash memory or other memory technology, expandable memory (e.g., USB sticks, compact flash cards, SD cards), CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 700. Any such computer storage media may be part of computing system environment 700.

In some embodiments, computing system environment 700 may also contain communications connection(s) 712 that allow it to communicate with other devices. Communications connection(s) 712 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Communications connection(s) 712 may allow computing system environment 700 to communicate over various networks types including, but not limited to, fibre channel, small computer system interface (SCSI), Bluetooth, Zigbee, Z-Wave, Ethernet, Wi-fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 712 connect to may run a plurality of network protocols including, but not limited to, transmission control protocol (TCP), user datagram protocol (UDP), internet protocol (IP), real-time transport protocol (RTP), real-time transport control protocol (RTCP), file transfer protocol (FTP), and hypertext transfer protocol (HTTP).

In further embodiments, computing system environment 700 may also have input device(s) 714 such as keyboard, mouse, a terminal or terminal emulator (either connected or remotely accessible via telnet, SSH, http, SSL, etc.), pen, voice input device, touch input device, remote control, etc. Output device(s) 716 such as a display, a terminal or terminal emulator (either connected or remotely accessible via telnet, SSH, http, SSL, etc.), speakers, light emitting diodes (LEDs), etc. may also be included. All these devices are well known in the art and are not discussed at length.

In one embodiment, computer readable storage medium 704 includes a device capability manager module 722, a device configurator module 724, a primary link manager module 726, and redundant link manager module 728. The device capability manager module 722 is operable to determine capabilities of a device according to flow diagram 600, for instance. In some embodiments, the device capability manager module 722 uses removable storage 708 and/or non-removable storage 710 to store, retrieve, and maintain device capability information. The device configurator module 724 may be used to determine configurations for devices and configuring devices according to flow diagrams 500 and 600, for instance. In some embodiments, the device configurator 724 configures a device to revert to the network of primary and/or secondary links before a failure occurs (e.g., when the device is added to the network, when another device is removed from the network). In other embodiments, the device configurator 724 configures the device to revert to the network of primary and/or secondary links when a link and/or device fails. In some embodiments, the device configurator module 724 uses removable storage 708 and/or non-removable storage 710 to retrieve device data. The primary link manager module 726 operates to establish and manage primary links with other devices as described above by reference to FIGS. 1A, 1C, 1D, 1F, and 4A-4C, for instance. The redundant link manager module 728 is operable to establish and manage secondary links with other devices as described above by reference to FIGS. 1B, 1C, 1E, 1G, 2A-2C, 3A-3C, 4D, and 6, for instance.

It is appreciated that implementations according to some embodiments that are described with respect to a computer system are merely exemplary and not intended to limit the scope of the embodiments. For example, some embodiments may be implemented on devices such as switches and routers, which may contain application specific integrated circuits (ASICs), field programmable gate arrays (FPGAs), etc. It is appreciated that these devices may include a computer readable medium for storing instructions for implementing methods according to flow diagrams 500 and 600.

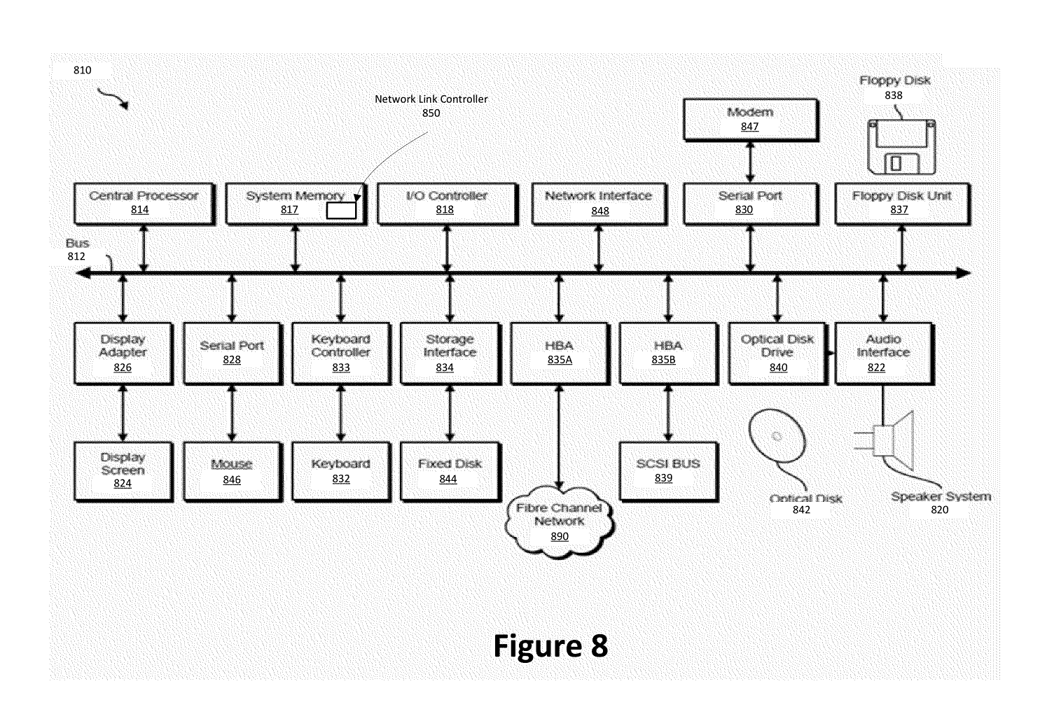

Referring now to FIG. 8, a block diagram of another exemplary computer system in accordance with some embodiments is shown. FIG. 8 depicts a block diagram of a computer system 810 suitable for implementing the present disclosure. Computer system 810 includes a bus 812 which interconnects major subsystems of computer system 810, such as a central processor 814, a system memory 817 (typically RAM, but which may also include ROM, flash RAM, or the like), an input/output controller 818, an external audio device, such as a speaker system 820 via an audio output interface 822, an external device, such as a display screen 824 via display adapter 826, serial ports 828 and 830, a keyboard 832 (interfaced with a keyboard controller 833), a storage interface 834, a floppy disk drive 837 operative to receive a floppy disk 838, a host bus adapter (HBA) interface card 835A operative to connect with a Fibre Channel network 890, a host bus adapter (HBA) interface card 835B operative to connect to a SCSI bus 839, and an optical disk drive 840 operative to receive an optical disk 842. Also included are a mouse 846 (or other point-and-click device, coupled to bus 812 via serial port 828), a modem 847 (coupled to bus 812 via serial port 830), and a network interface 848 (coupled directly to bus 812). It is appreciated that the network interface 848 may include one or more Ethernet ports, wireless local area network (WLAN) interfaces, Bluetooth interfaces, Zigbee interfaces, Z-Wave interfaces, etc., but are not limited thereto. System memory 817 includes a network link controller module 850 which is operable to manage links (e.g., primary links and redundant links) within the network. According to one embodiment, the network link controller module 850 may include other modules for carrying out various tasks. For example, network link controller module 850 may include the device capability manager module 724, the device configurator module 724, the primary link manager module 726, and the redundant link manager module 728, as discussed with respect to FIG. 7 above. It is appreciated that the network link controller module 850 may be located anywhere in the system and is not limited to the system memory 817. As such, residing of the network link controller module 850 within the system memory 817 is merely exemplary and not intended to limit the scope of the embodiments. For example, parts of the network link controller module 850 may reside within the central processor 814 and/or the network interface 848 but are not limited thereto.

Bus 812 allows data communication between central processor 814 and system memory 817, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 810 are generally stored on and accessed via a computer readable medium, such as a hard disk drive (e.g., fixed disk 844), an optical drive (e.g., optical drive 840), a floppy disk unit 837, or other storage medium. Additionally, applications can be in the form of electronic signals modulated in accordance with the application and data communication technology when accessed via network modem 847 or interface 848.

Storage interface 834, as with the other storage interfaces of computer system 810, can connect to a standard computer readable medium for storage and/or retrieval of information, such as a fixed disk drive 844. Fixed disk drive 844 may be a part of computer system 810 or may be separate and accessed through other interface systems. Network interface 848 may provide multiple connections to other devices. Furthermore, modem 847 may provide a direct connection to a remote server via a telephone link or to the Internet via an internet service provider (ISP). Network interface 848 may provide one or more connection to a data network, which may include any number of networked devices. It is appreciated that the connections via the network interface 848 may be via a direct connection to a remote server via a direct network link to the Internet via a POP (point of presence). Network interface 848 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 8 need not be present to practice the present disclosure. The devices and subsystems can be interconnected in different ways from that shown in FIG. 8. The operation of a computer system such as that shown in FIG. 8 is readily known in the art and is not discussed in detail in this application. Code to implement the present disclosure can be stored in computer-readable storage media such as one or more of system memory 817, fixed disk 844, optical disk 842, or floppy disk 838. The operating system provided on computer system 810 may be MS-DOS®, MS-WINDOWS®, OS/2®, UNIX®, Linux®, or any other operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The foregoing description, for purpose of explanation, has been described with reference to specific embodiments. However, the illustrative discussions above are not intended to be exhaustive or to limit the embodiments disclosed. Many modifications and variations are possible in view of the above teachings

What is claimed is:

1. A system comprising:
a plurality of devices in a network configured for communicating data through primary links coupling devices of the plurality of devices; and
a designated device configured to receive device data from the plurality of devices, wherein the designated device is further configured to identify a set of devices from the plurality of devices that is operable to establish redundant links in the network, wherein the designated device is further configured to determine configuration data for each device in the set of devices, wherein the designated device is further configured to send the configuration data to the set of devices, wherein the configuration data is operable to establish redundant links for devices in the set of devices in case of a primary link failure.

2. The system as described in claim 1, wherein the designated device is further configured to update the set of devices and the associated configuration data in response to a change to the network, wherein the change is an addition of a device to the network or a removal of a device from the network.

3. The system as described in claim 1, wherein the primary link failure causes the set of devices to establish the redundant links for the devices in the set of devices according to the determined configuration data.

4. The system as described in claim 1, wherein the device data comprises device identification, communication capabilities of devices in the plurality of devices, and geolocation of devices in the plurality of devices.

5. The system as described in claim 1, wherein the redundant links are arranged according to a mesh topology.

6. A system comprising:
a plurality of devices forming a communication network, wherein devices of the plurality of devices are networked via their respective primary link; and
a first device of the plurality of devices coupled to a second device of the plurality of device, wherein the first device and the second device are configured to establish a redundant link coupling the first device to the second device to maintain communication between the first device and the second device in presence of a failure associated with communication through the primary link coupling the first device to the second device.

7. The system as described in claim 6 further comprising a designated device configured to determine configuration data for the first and second devices and to send the configuration data to the first and second devices to establish the redundant link responsive to the failure associated with communication through the primary link coupling the first device to the second device.

8. The system as described in claim 6, wherein the first and second devices are further configured to share device data with each other to determine configuration data associated therewith to establish the redundant link responsive to the failure associated with communication through the primary link coupling the first device to the second device.

9. The system as described in claim 8, wherein the device data comprises device identification, communication capabilities of the first and second devices, and geolocation of the first and second devices.

10. The system as described in claim 6 further comprising a third device being added to the communication network, wherein the third device is configured to communicate device data associated therewith with the first device through a primary link of the third device.

11. The system as described in claim 6 further comprising a third device being added to the communication network, wherein the third device is configured to communicate device data associated therewith with the first device through a redundant link of the third device.

12. The system as described in claim 6 further comprising a third device in communication with the first and the second devices, wherein the first device, the second device, and the third device form a set of devices, wherein remaining devices of the formed set of devices maintain communication when one device in the set of devices is removed.

13. The system as described in claim 6, wherein the first device comprises a first communication interface of a first type and a second communication interface of a second type, wherein the second device comprises a first communication interface of the first type and a second communication interface of the second type, wherein the first and second devices communicate through the primary link via their respective first communication interface, and wherein the first and second devices communicate through the redundant link via their respective second communication interface.

14. The system as described in claim 13, wherein the first type is based on a wired link and wherein the second type is based on a wireless link.

15. A system comprising:
a first device comprising a first communicating interface and a second communicating interface; and
a second device comprising a first communicating interface and a second communicating interface, wherein the first communicating interface of the second device is coupled to the first communicating interface of the first device via a primary link, wherein the first device and the second device are configured to communicate respective device data associated therewith with one another, and wherein the respective device data associated therewith is used by the first device and by the second device to configure communication between the first device and the second device through their respective second communicating interface via a redundant link in response to a failure associated with communication via the primary link.

16. The system as described in claim 15, wherein the respective device data associated with the first and second devices are shared between the first and second devices through a broadcast protocol.

17. The system as described in claim 15, wherein the first communication interfaces of the first and second devices are of a first type, wherein the second communication interfaces of the first and second devices are of a second type.

18. The system as described in claim 17, wherein the first type is based on a wired link and wherein the second type is based on a wireless link.

19. The system as described in claim 17, wherein the second type is a radio frequency (RF) interface.

20. The system as described in claim 17, wherein the second type is a Bluetooth interface.

21. The system as described in claim 15, wherein the respective device data is communicated through an extension of a link layer discovery protocol (LLDP).
